(19) United States
(12) Patent Application Publication
(10) Pub. No.: US 2019/0275764 A1
(43) Pub. Date: Sep. 12, 2019

(54) MULTILAYER FILM FOR RESEALABLE PACKAGING

(71) Applicant: BOSTIK S.A., Courbevoie (FR)

(72) Inventors: Christophe ROBERT, Thourotte (FR); Christophe NOTTEAU, Noyon (FR)

(73) Assignee: BOSTIK S.A., Courbevoie (FR)

(21) Appl. No.: 16/426,618

(22) Filed: May 30, 2019

Related U.S. Application Data
(63) Continuation of application No. 13/825,879, filed on May 21, 2013, now abandoned.

(30) Foreign Application Priority Data
Sep. 27, 2010 (FR) 1057739

(51) Int. Cl. B32B 7/12; B65D 77/20; B32B 25/08; B32B 25/14; C09J 153/02; B32B 27/08

(52) U.S. Cl. CPC B32B 7/12; B65D 77/20; B32B 25/08; B32B 25/14; C09J 153/02; C08L 53/02; B32B 2270/00; B32B 2250/24; B32B 2250/03; Y10T 428/269; B32B 2439/70; B32B 27/08

(57) ABSTRACT

The invention relates to: 1) a multilayer film for resealable packaging, wherein said multilayer film includes a layer having a thickness of between 7 and 300 μm and consisting of a hot-melt pressure-sensitive adhesive composition having an MFI of 0.01 and 100 g/10 minutes, including 40 to 70% of an SIS styrene block copolymer mixture having a styrene content of 10 to 16% and a diblock copolymer content of 60% to 90%; and 30 to 60% of one or more tackifying resins having a softening temperature of between 5 and 140° C.; 2) a method for manufacturing said film by means of coextrusion; and 3) the use of said film for manufacturing resealable cartons.

A subject matter of the present invention is a multilayer film comprising a layer composed of an extrudable hot-melt pressure-sensitive adhesive composition, a process for the manufacture of said film and is used for the manufacture of resealable packagings (or cartons) intended in particular for the packaging of foodstuffs, in particular of perishable foodstuffs.

Sealable cartons are used in the food processing industry and mass marketing for packaging perishable foods, in particular fresh products. Such packagings are described by the patents and patent applications U.S. Pat. No. 4,673,601, EP 1053952 and WO 02/064694.

After the packaging has been opened for the first time and a portion of the foodstuff present therein has been consumed, the user can manually reseal the packaging in a substantially hermetic fashion and consequently provide, if appropriate after placing in a refrigerator, the storage of the remaining portion of the foodstuff. A sequence of reopenings and resealings is also possible.

These packagings generally comprise a container (or receptacle) and a seal forming a lid, which are hermetically attached to one another by welding.

The receptacle, which is more or less deep and relatively rigid, is composed of a multilayer sheet (also described as complex or composite sheet) having a minimum thickness of 200 μm, generally between 200 and 1000 μm. This sheet is thermoformed, so as to exhibit a flat bottom, on which the foodstuff rests, and a perimeter in the form of a flat band. This perimeter, generally parallel to the bottom, is bonded by welding to the flexible and flat seal, which is composed of a multilayer film (also described as complex or composite film), generally with a thickness of between 40 and 150 μm, and which is sometimes denoted by the name of sealing film.

During the opening of the packaging, the sealing film is manually separated from the receptacle at the flat band of the perimeter. This operation results in the appearance of an adhesive layer at this flat band, both on the sealing band and on the receptacle band which were previously in contact. These 2 adhesive layers (continues or noncontinuous) “referred to as daughters” result from the rupturing of an initial or “mother” adhesive layer or, possibly, from its separation (or detachment) from one of the 2 layers of the multilayer complex film which are adjacent to it. The initial adhesive layer is thus one of the layers of said multilayer complex film, which is itself an element included either in the composite sheet which forms the receptacle or, possibly, in the sealing film.

The 2 daughter adhesive layers which are present, after opening the packaging, on the bands located on the respective perimeter of the receptacle and of the seal are thus facing one another. Thus, it is sufficient to reposition the seal over the receptacle, in accordance with their position in the packaging before opening, in order to bring the 2 bands of daughter adhesive layers back into contact. Simple manual pressure then makes it possible to obtain the resealing of the packaging.

The adhesive substance which forms the mother and daughter adhesive layers is thus necessarily a pressure-sensitive-adhesive (PSA).

The ease of opening such packagings is closely related to the properties of the PSA and more particularly to the force which has to be applied, during the opening of the packaging (hereinafter denoted first opening), in order to obtain the rupturing of the mother adhesive layer and/or its separation from one of the 2 layers which are adjacent to it in the multilayer composite film mentioned above.

The ability of the packaging to be resealed and the quality of the resealing obtained (hereinafter denoted first resealing) are also important in order to again make available a packaging which is substantially hermetic and thus capable of providing the storage of its contents. The quality of the first resealing is also closely related to the properties of the PSA. It is evaluated by the force which has to be applied, during the reopening (hereinafter denoted by second opening), in order to again obtain the rupturing and/or the detachment of the adhesive layer which was formed by the repositioning of the 2 daughter adhesive films, followed by the manual pressure applied to the perimeter of the packaging.

U.S. Pat. No. 4,673,601 describes a composite film which can be used for the manufacture of resealable packagings comprising an adhesive layer based on hot-melt adhesives, for example copolymers of Ethylene and Vinyl Acetate (EVA) and Styrene/Butadiene/Styrene (SBS) and Styrene/Isoprene/Styrene (SIS) block copolymers.

Patent application EP 1053952 teaches a resealable packaging with a container which comprises a complexable layer, an adhesive layer and a tearable welding layer. This adhesive is a pressure-sensitive adhesive which is described in a very general fashion.

International application WO 02/064694 discloses a multilayer film comprising an adhesive layer composed of a hot-melt pressure-sensitive adhesive composition comprising 65% of a mixture of styrene block copolymers of the styrene/isoprene/styrene type, the content of styrene units of which is 18% and the content of SI diblock of which is 45%. Said film is manufactured by blown film coextrusion for the purpose of the subsequent use thereof in a resealable packaging.

The application EP 2 123 444 describes a complex film comprising 2 thin layers of materials bonded to one another via a layer of an adhesive composition based on styrene block copolymers, the thickness of which does not exceed 10 μm. This film is not suitable for the manufacture of resealable packagings.

One aim of the present invention is to provide a multilayer film which is suitable for the manufacture of a resealable packaging and which makes it possible to lower the force of first opening of the packaging, while maintaining at substantially the same level the quality of the subsequent resealing (or first resealing).

Another aim of the present invention is to provide a multilayer film which in addition makes it possible to also improve the quality of the resealing, in particular of the first resealing.

Another aim of the present invention is to provide a multilayer film which makes it possible to lower the force of first opening, while increasing the force of second opening.

Another aim of the present invention is to provide a multilayer film which makes it possible to achieve the preceding aims at the usual temperature of storage of a packaging in a refrigerator.

Another aim of the present invention is to provide a multilayer film capable of being manufactured by coextrusion from starting materials conditioned in the form of granules, in particular by blown film coextrusion, for the purpose of the manufacture of a resealable packaging.

It has now been found that these aims can be achieved, in all or in part, by means of the multilayer film according to the invention which is described below.

A subject matter of the present invention is thus firstly a multilayer film comprising 2 thin layers of thermoplastic material bonded to one another by a continuous layer, characterized in that said layer has a thickness of between 7 and 300 μm and is composed of a hot-melt pressure-sensitive adhesive composition having a melt flow index (or MFI) ranging from 0.01 to 100 g/10 minutes comprising:
from 40 to 70% of a mixture of styrene block copolymers, said mixture having a total content of styrene units ranging from 10 to 16% and consisting of:
   from 60 to 90% of one or more diblock copolymers of Styrene/Isoprene (SI) type, and of
   from 10 to 40% of one or more linear Styrene/Isoprene/Styrene (SIS) triblock copolymers, and
from 30 to 60% of one or more tackifying resins having a softening temperature of between 5 and 140° C.

The above percentages and also those, unless otherwise indicated, used generally in the present text to express amounts correspond to weight/weight percentages. It is also specified that the above percentages for the mixture of block copolymers and the tackifying resin, as well as the percentages indicated for optional components (specified subsequently in the present text) included in the pressure-sensitive adhesive composition described above, are percentages relating to the total weight of said composition.

The melt flow index (or MFI) is measured at 190° C. and for a total weight of 2.16 kg, in accordance with condition d) of the standard ISO 1133. The MFI is the weight of composition (placed beforehand in a vertical cylinder) which flows in 10 minutes through a die having a fixed diameter, under the effect of a pressure exerted by a loaded piston having a total weight of 2.16 kg. Unless otherwise mentioned, the MFI values indicated in the present text were measured under these same conditions.

The hot-melt pressure-sensitive adhesive compositions having an MFI ranging from 2 to 70 g/10 minutes are more particularly preferred.

The SI and SIS copolymers which can be used in the composition constituting the bonding layer of the film according to the invention have a weight-average molar mass M_{w} of between 60 kDa and 400 kDa. Unless otherwise indicated, the weight-average molar masses M_{w} which are given in the present text are expressed in daltons (Da) and are determined by Gel Permeation Chromatography, the column being calibrated with polystyrene standards.

According to a preferred alternative form of the multilayer film according to the invention, the content of SI diblocks of the mixture of styrene block copolymers can vary from 60 to 80% and more preferably still from 70 to 80%.

According to another preferred alternative form, the overall content of styrene units of the mixture of styrene block copolymers can vary from 13 to 16%.

The copolymer of SIS and SI type which are capable of being employed in the preparation of the hot-melt pressure-sensitive adhesive composition are commercially available. Said copolymers are themselves available in the form triblock/diblock mixtures. Kraton® D1113BT from Kraton and Quintac® 3520 from Zeon Chemicals are examples of such mixtures.

Kraton® D1113BT is a mixture which has an overall content of styrene units of 16%, and which is composed of 45% of linear SIS triblock copolymer with an M_{w} of approximately 250 kDa and of 55% of SI diblock copolymer with an M_{w} of approximately 100 kDa. Quintac® 3520 is a mixture which is composed, respectively of 22% and 78% of SIS triblock (M_{w} approximately 300 kDa) and SI diblock (M_{w} approximately 130 kDa), the total content of styrene units of which is 15%.

According to another preferred alternative form, the content of mixture of styrene block copolymers of the composition is less than or equal to 60%. A better resealing of the packaging is then advantageously obtained, which is reflected by a greater force of second opening.

The tackifying resin or resins which can be used in the composition have weight-average molar masses M_{w} generally of between 300 and 5000 Da and are chosen in particular from:
(i) rosins of natural or modified origin, such as, for example, the rosin extracted from pine gum, wood rosin extracted from tree roots and their derivatives which are hydrogenated, dehydrogenated, dimerized, polymerized or esterified by monoalcohols or polyols, such as glycerol;
(ii) resins obtained by hydrogenation, polymerization or copolymerization (with an aromatic hydrocarbon) of mixtures of unsaturated aliphatic hydrocarbons having approximately 5, 9 or 10 carbon atoms resulting from petroleum fractions;
(iii) terpene resins generally resulting from the polymerization of terpene hydrocarbons, such as, for example, monoterpene (or pinene), in the presence of Friedel-Crafts catalysts, which are optionally modified by the fraction of phenols;
(iv) copolymers based on natural terpenes, for example styrene/terpene, α-methylstyrene/terpene and vinyltoluene/terpene.

The softening temperature (or point) of the tackifying resin which can be used in the composition according to the invention can vary from 5 to 140° C. The softening temperature is determined in accordance with the standardized test ASTM E 28, the principle of which is as follows. A brass ring with a diameter of approximately 2 cm is filled with the test resin in the molten state. After cooling to ambient temperature, the ring and the solid resin are placed horizontally in a thermostatedly controlled bath of glycerol, the temperature of which can vary by 5° C. per minute. A steel ball with a diameter of approximately 9.5 mm is centered on the disk of solid resin. The softening temperature is—during the phase of rise in the temperature of the bath at a rate of 5° C. per minute—the temperature at which the disk of resin yields by a height of 25.4 mm under the weight of the ball.

According to a preferred alternative form, use is made of aliphatic tackifying resins and more preferably still of aliphatic resins belonging to the categories (ii) or (iii), for which mention may be made, as examples of commercially available resin, of:

(ii) Escorez® 1310 LC, available from Exxon Chemicals, which is a resin obtained by polymerization of a mixture of unsaturated aliphatic hydrocarbons having approximately 5 carbon atoms and which has a softening temperature of 94° C. and an Mw of approximately 1800 Da; Escorez® 5400, also from Exxon Chemicals, which is a resin obtained by polymerization and then hydrogenation of a mixture of unsaturated aliphatic hydrocarbons having approximately 9 or 10 carbon atoms and which has a softening temperature of 100° C. and an Mw of approximately 570 Da;

(iii) Dercolyte® S115, available from Dérivés Résiniques et Terpéniques (or DRT), which is a terpene resin having a softening temperature of 115° C. and an Mw of approximately 2300 Da.

The adhesive composition employed in the multilayer film according to the invention preferably comprises from 50 to 70% of the mixture of SI diblock and SIS triblock copolymers and from 30 to 50% of the tackifying resin or resins.

The adhesive composition can also comprise from 0.1 to 2% of one or more stabilizers (or antioxidants). These compounds are introduced in order to protect the composition from damage resulting from a reaction with oxygen which is capable of being formed by the action of heat, light or residual catalysts on certain starting materials, such as the tackifying resins. These compounds can include primary antioxidants, which trap the free radicals and are generally substituted phenols, such as Irganox® 1010 from CIBA. The primary antioxidants can be used alone or in combination with other antioxidants, such as phosphites, for example Irgafos® 168, also from CIBA, or also with UV stabilizers, such as amines.

The adhesive composition 8 can also comprise a plasticizer but in an amount not exceeding 5%. Use may be made, as plasticizer, of a paraffinic and naphthenic oil (such as Primol® 352 from Esso) optionally comprising aromatic compounds (such as Nyflex 222B).

Finally the adhesive composition can comprise inorganic or organic fillers, pigments or dyes.

According to an alternative form of the invention, the thickness of the bonding adhesive layer is between 10 and 300 μm, preferably between 10 and 50 μm and more preferably still between 10 and 30 μm. According to another alternative form of the invention, said thickness is between 7 and 50 μm and preferably between 7 and 30 μm.

Said adhesive layer makes possible the bonding between a complexable thin layer and a sealable and cleavable thin layer.

The complexable layer can be complexed (or laminated) with other layers for the preparation of the packaging, for example with a rigid layer for the preparation of the receptacle.

The sealable and cleavable layer makes it possible to provide, at the perimeter along which the receptacle is bonded by welding to the seal, the first opening of the packaging, by means of a cleavable embrittled region. After opening, the embrittled region results in the appearance of:
the mother adhesive layer on the sealing band and/or on the receptacle band which were in contact in the closed packaging, and/or
2 daughter adhesive layers which result from the rupturing of the mother adhesive layer and which are located on the sealing band and/or the receptacle band.

The material used to form the 2 thin layers bonded to one another by the bonding adhesive layer is generally a thermoplastic polymer (identical or different from the 2 layers), such as:
polyethylene (PE),
polypropylene (PP),
a copolymer based on ethylene and propylene,
polyamide (PA),
polyethylene terephthalate (PET), or also
an ethylene-based copolymer, such as, for example, a copolymer grafted with maleic anhydride, a copolymer of ethylene and vinylacetate (EVA), a copolymer of ethylene and vinyl alcohol (EVOH), or a copolymer of ethylene and an alkyl acrylate, such as methylacrylate (EMA) or butylacrylate (EBA),
polystyrene (PS),
polyvinyl chloride (PVC),
polyvinylidene fluoride (PVDF),
a lactic acid polymer (PLA), or
polyhydroxyalkanoate (PHA).

According to an alternative embodiment, the multilayer film according to the invention is a three-layer film consisting of the adhesive layer and the 2 adjacent layers.

According to another alternative embodiment, the multilayer film according to the invention comprises, in addition to the 2 thin layers adjacent to the adhesive layer, other thin layers necessary for the preparation of the packaging, such as, for example:
a rigid layer necessary for the mechanical strength of the receptacle, or
a printable layer, or
a layer having a barrier effect against oxygen, water vapor or else carbon monoxide.

The materials which can be used to form said layers can be identical or different and generally comprise thermoplastic polymers which can be chosen from the polymers mentioned above for the 2 adjacent thin layers.

The thickness of the 2 thin layers adjacent to the adhesive layer and the other layers employed in the multilayer layer film according to the invention is capable of varying within a wide range extending from 5 to 150 μm.

The multilayer film according to the invention can be manufactured by deposition of an appropriate amount of the composition according to the invention on one of the 2 thin layers of material, followed by application of the 2nd thin layer and hot pressing. It can also be manufactured by coextrusion.

The present invention also relates to a process for the manufacture of a multilayer film as defined above, characterized in that it comprises the coextrusion of the hot-melt pressure-sensitive adhesive composition with the materials of the 2 adjacent thin layers.

Preferably, the hot-melt pressure-sensitive adhesive composition and the constituent materials of the 2 thin layers are fed into the coextrusion device in the form of granules with a size of between 1 and 10 mm, preferably between 2 and 5 mm. The pressure-sensitive adhesive composition employed in the multilayer film according to the invention makes it possible, particularly advantageously, to provide both the properties required for said film and the possibility of a presentation of said composition in the form of the abovementioned granules. The other layers possibly included in the multilayer film can be obtained either by the incorporation, in the coextrusion device, of the corresponding constituent materials in the form of granules of the same size or by a process of complexing the film directly resulting from the coextrusion.

The adhesive composition can be prepared, in this form of granules, by simple mixing of the ingredients under hot conditions, between 150 and 200° C., preferably at approximately 160° C., using a twin-screw extruder equipped with a tool for cutting up the product extruded at the outlet of the die.

The blown film coextrusion process is more particularly preferred, in particular for the manufacture of a multilayer film in which the thickness of the adhesive layer is between 7 and 50 μm, preferably between 10 and 50 μm and more preferably still between 10 and 30 μm.

The present invention also relates to the use of the multilayer film as described above for the manufacture of resealable cartons, preferably for the manufacture of the sealing film.

The following examples are given purely by way of illustration of the invention and should not under any circumstances be interpreted as limiting the scope thereof.

### EXAMPLE 1

The adhesive composition shown in the following table, to which 0.5% of Irganox® 1010 is added, is prepared in the form of a viscous liquid at 160° C. by simple mixing of the ingredients at this temperature using a twin-screw extruder.

The MFI is shown in the table.

Measurement of the Force of First Opening by Peeling at 5° C.:

A multilayer film including an adhesive layer formed on said composition is prepared in the following way.

Approximately 8 g of the adhesive composition are placed on a square PET sheet with a side length of 15 cm and a thickness of 50 μm. A second PET sheet identical to the first is then applied and a pressure of 100 kg/cm² is exerted on the assembly for 2 minutes, at a temperature of 120° C., using a hydraulic press. The thickness of the adhesive layer in the multilayer film, monitored using a sliding caliper, is approximately 250 μm.

The rectangular test specimen of 1 cm by 10 cm is cutout from the multilayer film thus obtained, a 180° peel test being carried out on this test specimen. For this, the 2 layers of PET film included in this band are detached from one of the 2 ends of this test specimen and over approximately 2 cm, and the 2 free ends obtained are attached to 2 holding devices (known as jaws) respectively connected to a stationary part and a movable part of a tensile testing device which are located on a vertical axis.

While a drive mechanism imparts a uniform rate of 100 mm/minute to the movable part, resulting in the detachment of the 2 PET layers, the detached ends of which are gradually displaced along a vertical axis with the formation of an angle of 180°, a force sensor connected to said movable part measures the force withstood by the test specimen thus held. The assembly consisting of the test specimen, the stationary jaws and the movable jaws to which said test specimen is attached is placed in a thermostatically controlled chamber maintained at a temperature of 5° C., so that the detachment is carried out after stabilization at this temperature.

The result is expressed in N/cm.

Measurement of the Force of Second Opening by Peeling at 5° C.:

The 2 PET layers of the preceding test specimen are, after they have been detached, repositioned facing one another and brought into contact manually. They are then subjected to a pressure exerted by means of a roller with a weight of 2 kg, with which a to-and-fro movement is carried out along a direction parallel to the length of the test specimen.

The preceding peel test is then repeated on the multilayer thus obtained, after stabilizing for 15 minutes at 5° C.

The result is expressed in N/cm.

### EXAMPLE 2-4

Example 1 is repeated using, for the ingredients of the compositions, the contents shown in the table.

The forces of 1st and 2nd openings obtained are also shown in the table.

### Example A (Comparative)

Example 1 is repeated using a mixture of Kraton® D1111 and Kraton® D1113BT in the proportions shown, so as to obtain the composition exemplified by the application WO 02/064694.

It is observed that the force of 1st opening of examples 1 to 4 is lowered with respect to that of example A, indicating an easier opening of the resealable packaging. Furthermore, examples 2 to 4 exhibit a significant increase in the force of 2nd opening with respect to that of example A, which reflects an improvement in the quality of the resealing of the packaging once opened.

| | TABLE | | | | |
|---|---|---|---|---|---|
| | Content in % | | | | |
| Ingredient | Example 1 | Example 2 | Example 3 | Example 4 | Example A |
| Quintac ® 3520 | 65 | 60 | 60 | 55 | — |
| Kraton ® D1111 | — | — | — | — | 18 |
| Kraton ® D1113BT | — | — | — | — | 47 |
| Escorez ® 1310 LC | 17.5 | 20 | 25 | 22.5 | 17.5 |
| Dercolyte ® S115 | 17.5 | 20 | 15 | 22.5 | 17.5 |
| MFI | 20 | 23 | 27 | 35 | 21 |
| Content of styrene units of the | 15 | 15 | 15 | 15 | 18 |
| mixture of styrene block | | | | | |
| copolymers | | | | | |
| Content of diblocks of the | 78 | 78 | 78 | 78 | 45 |
| mixture of styrene block | | | | | |
| copolymers | | | | | |
| Force of 1st opening at 5° C. | 25 | 30 | 33 | 35 | 43 |
| (N/cm) | | | | | |
| Force of 2nd opening at 5° C. | 18 | 22 | 24 | 24 | 21 |
| (N/cm) | | | | | |

1. A multilayer film comprising 2 thin layers of thermoplastic material bonded to one another by a continuous layer, characterized in that said layer has a thickness of between 7 and 300 μm and is composed of a hot-melt pressure-sensitive adhesive composition having a melt flow index (or MFI) ranging from 0.01 to 100 g/10 minutes comprising:
from 40 to 70% of a mixture of styrene block copolymers, said mixture having a total content of styrene units ranging from 10 to 16% and consisting of:
from 60 to 90% of one or more diblock copolymers of Styrene/Isoprene (SI) type, and of
from 10 to 40% of one or more linear Styrene/Isoprene/Styrene (SIS) triblock copolymers, and
from 30 to 60% of one or more tackifying resins having a softening temperature of between 5 and 140° C.

2. The multilayer film as claimed in claim 1, characterized in that the pressure-sensitive adhesive composition has an MFI ranging from 2 to 70 g/10 minutes.

3. The multilayer film as claimed in claim 1, characterized in that the content of SI diblocks of the mixture of styrene block copolymers varies from 60 to 80%.

4. The multilayer film as claimed in claim 1, characterized in that the content of SI diblocks of the mixture of styrene block copolymers varies from 70 to 80%.

5. The multilayer film as claimed in claim 1, characterized in that the content of mixture of styrene block copolymers of the composition is less than or equal to 60%.

6. The multilayer film as claimed in claim 1, characterized in that the tackifying resin has a weight-average molar mass M_{w} of between 300 and 5000 Da and is chosen from:
(i) rosins of natural or modified origin, such as, for example, the rosin extracted from pine gum, wood rosin extracted from tree roots and their derivatives which are hydrogenated, dehydrogenated, dimerized, polymerized or esterified by monoalcohols or polyols, such as glycerol;
(ii) resins obtained by hydrogenation, polymerization or copolymerization (with an aromatic hydrocarbon) of mixtures of unsaturated aliphatic hydrocarbons having approximately 5, 9 or 10 carbon atoms resulting from petroleum fractions;
(iii) terpene resins generally resulting from the polymerization of terpene hydrocarbons, such as, for example, monoterpene (or pinene), in the presence of Friedel-Crafts catalysts, which are optionally modified by the fraction of phenols;
(iv) copolymers based on natural terpenes, for example styrene/terpene, α-methylstyrene/terpene and vinyltoluene/terpene.

7. The multilayer film as claimed in claim 1, characterized in that the tackifying resin is aliphatic.

8. The multilayer film as claimed in claim 7, characterized in that the resin belongs to the categories (ii) or (iii).

9. The multilayer film as claimed in claim 1, characterized in that the pressure-sensitive adhesive composition comprises a plasticizer in an amount not exceeding 5%.

10. The multilayer film as claimed in claim 1, characterized in that the thickness of the bonding adhesive layer is between 10 and 300 μm.

11. The multilayer film as claimed in claim 1, characterized in that the thickness of the bonding adhesive layer is between 10 and 50 μm.

12. A three-layer film as defined in claim 1.

13. A process for the manufacture of the multilayer film as defined in claim 1, characterized in that it comprises the coextrusion of the hot-melt pressure-sensitive adhesive composition with the materials of the 2 adjacent thin layers.

14. The process for the manufacture of the multilayer film as claimed in claim 13, characterized in that the hot-melt pressure-sensitive adhesive composition and the constituent materials of the 2 thin layers are fed into the coextrusion device in the form of granules with a size of between 1 and 10 mm.

15. The process for the manufacture of the multilayer film as claimed in claim 13, characterized in that the coextrusion is carried out by blown film coextrusion.

16. In a process for the manufacture of resealable cartons, said process comprising employing a multilayer film, the improvement comprising using as said film a multilayer film according to claim 1.

17. A resealable carton to which carton has been applied a multilayer film according to claim 1.
